(19) United States
(12) Patent Application Publication
(10) Pub. No.: US 2006/0224541 A1
(43) Pub. Date: Oct. 5, 2006

(54) Method and apparatus for pattern recognition for knowledge capture and customization

(76) Inventor: Gerald Howard Barney Ross, Montreal (CA)

Correspondence Address: KIRKPATRICK & LOCKHART NICHOLSON GRAHAM LLP, STATE STREET FINANCIAL CENTER, ONE LINCOLN STREET, BOSTON, MA, 02111-2950, US

(21) Appl. No.: 11/085,802

(22) Filed: Mar. 21, 2005

(51) Int. Cl. G06N 5/02

(52) U.S. Cl. 706/46

(57) ABSTRACT

A method and apparatus for use in providing a framework for capturing and organizing knowledge in learning. In one aspect of the invention, the method of an embodiment of the invention includes the steps of determining patterns that experts use across different situations; customizing concepts and tools for people who lack expertise based on the patterns; and integrating and packaging learning modules for competencies required to execute the patterns. In another aspect of the invention, the apparatus of the invention in one embodiment includes a graphical interface for teaching learning strategies. The graphical interface includes topics; learning points; and learning strategies. The topics, learning points and learning strategies are associated to permit a user to move between them.

### FIELD OF THE INVENTION

The invention relates in general to the field of teaching and more specifically to the field of customized teaching techniques.

### BACKGROUND OF THE INVENTION

All organizations have a relatively small number of high performers or “stars.” These are individuals who not only are talented, but have an almost instinctive ability to succeed. Law firms, corporations and public-sector organizations all have this scarce resource of unusual talent. The knowledge these individuals have is often called “tacit,” that is, it is in their heads, not in books or universities.

Traditionally, the way these “stars” passed on their knowledge was through the apprenticeship process. Juniors worked with their superiors over a number of years, thereby learning the “tricks of the trade” (the subtle nuances that often make the difference between success and failure).

In recent years, however, downsizing, mergers, acquisitions and other uncertainties have completely disrupted this time-honored means of learning. Few individuals work with their bosses for very long. Furthermore, the short-term pressures for performance often militate against this more informal kind of learning.

For example, over the last 10 years, lawyers, engineers, healthcare and other professionals have awakened to the critical need for management skills. People with solid technical training are increasingly leading complex organizations. Lawyers, for example, who once had small, single location practices, find themselves managing global enterprises with offices worldwide. Engineers must learn to work effectively on cross-functional teams and, later in their careers, run complex business units on an international scale. Even priests need to understand budgeting in their parishes and how to provide leadership for their volunteers and parishioners.

The sheer breadth of management skills required by these professionals includes such basic competencies as how to deal with people, read financial statements, understand return on investment and the fundamentals of marketing. In short, management has become a critical “life skill” for survival, both personally and professionally.

### SUMMARY OF THE INVENTION

The invention related to a method and apparatus for use in providing a framework for capturing and organizing knowledge in learning.

In one aspect of the invention, the method of an embodiment of the invention includes the steps of determining patterns that experts use across different situations; customizing concepts and tools for people who lack expertise based on the patterns; and integrating and packaging learning modules for competencies required to execute the patterns. The patterns comprise a hierarchy of sub-patterns and wherein each of the sub-patterns has a predefined relationship with other sub-patterns. Further, each pattern comprises a plurality of learning points and the relationship between the learning points.

In another embodiment, the invention includes a method for use in aiding learning. The method includes identifying standard scenarios; identifying strategies applied by experienced actors to the standard scenarios; and providing learning modules for concepts and tools that are customized to a learner's context to help the learner learn the strategies.

In yet another embodiment, the method is for organizing learning and includes the steps of: capturing patterns used by experts; organizing into a framework the patterns used by experts; identifying competencies required to execute the patterns; and customizing cases to put the competencies into context. The step of capturing the patterns used by experts includes the steps of: defining learning points; determining the interrelationship between learning points; identifying strategies for teaching each learning point; and identifying ways to evaluate the results of the teaching strategy.

In another aspect of the invention, the apparatus of the invention in one embodiment includes a common graphical interface for teaching learning strategies. The graphical interface includes topics; learning points; and learning strategies. The topics, learning points and learning strategies are associated to permit a user to move between them. In another embodiment the graphical interface further includes contextual materials; and navigation icons.

### BRIEF DESCRIPTION OF THE DRAWINGS

The invention may be understood with reference to the specification and the appended drawings in which:

FIG. 1 is a diagram of an exemplary play in football, the “Trips Left 346 R-Swing” play;

FIG. 2 is a diagram showing an embodiment of a model of the levels of patterns available to a specific situation;

FIG. 3 is a diagram of the an embodiment of a model of FIG. 2 showing the portions of the model as seen by individuals of varying amounts of expertise;

FIG. 4 is a diagram of an embodiment of a client matrix according to the invention;

FIG. 5 is an embodiment of a universal pattern book according to the invention;

FIG. 6 is a flow chart of an embodiment of the invention as used for capturing knowledge;

FIG. 7 is a flow chart of an embodiment of the invention for producing a learning module;

FIG. 8 is an embodiment of the design dashboard according the invention; and

FIG. 9 is a flow chart of an embodiment of the invention showing the steps used to interlink the learning points, the supporting materials and the strategies in a design dashboard.

### DESCRIPTION OF A PREFERRED EMBODIMENT

The invention represents a framework for capturing and organizing knowledge to address two major challenges in learning in a given field: 1. how to capture the “patterns” based on how experts resolve complex issues within that field (for example management issues) and 2. how to easily customize those concepts and tools for people outside the field expert group (for example lawyers, doctors, engineers, etc.)

The invention includes a framework and process for organizing learning that: Captures and categorizes the patterns used by high performers to address issues based on their “tacit” knowledge of the field. Provides a framework for a universal set of common patterns that underlie decision-making in most situations in the field Integrates and packages:

the competencies required to execute the patterns. This includes addressing the complex issues involves integrating multiple competencies, and then executing them through appropriate patterns;
the customized cases, articles and examples that put these competencies in context for the non-expert learner;
the appropriate learning processes tailored to the workflow in the organization.

Considering each of these steps individually, the invention first captures and organizes the patterns used by experts.

The invention is based on the fundamental principle that experts use a limited set of recurring patterns to deal with the apparent complexity of many situations. For example, an investment banker often involves a complex set of considerations when trying to land a contract with a stubborn client. He or she must deal with the circumstances at hand including, the personalities of the individuals involved, and the priorities of the particular organization, as well as other factors. Here, an expert banker quickly sizes up a situation and cuts through a very complex process. To a fellow colleague, it might seem like a brilliant coup, easily resolving the situation in a way that only a star can do.

In such cases, the lion's share of the knowledge lies in the minds of the experts or high performers. This knowledge goes beyond typical textbook or course material to include: the ability to quickly size up a situation and to implement appropriate patterns and the use of key “tricks of the trade”, often gained by experience, which clearly make the difference between success and failure in a given situation.

The question is how to ferret out the expert's modus operandi. Unfortunately, there is no easy way to “download” an individual's knowledge so that it is accessible to others. Furthermore, experts often cannot easily articulate exactly how they succeed. They achieve effortlessly, acting as if almost by instinct.

Unfortunately, computers are of little use in understanding these patterns. They produce a sea of analysis but little insight. The basic problem is that the real information needed to decode such situations is not in the computer in the first place. The computer can only analyze the information that is in its database and cannot deal with external and subjective factors.

Ironically, the human mind is far more adept at deciphering these patterns than the computer. The expert mind discerns the key patterns with relatively few data points. In the same way that a ship's position at sea can be determined by triangulating on only three reference points, experienced professionals can quickly get the lay of the land using a few simple indicators.

Paradoxically, the expert really draws on a very limited repertoire of patterns and then improvises in response to moves by the other parties. In a football game, for example, a team also has a limited set of plays that it can execute, captured in a “playbook.” This provides the core repertoire of patterns that can be executed during a game.

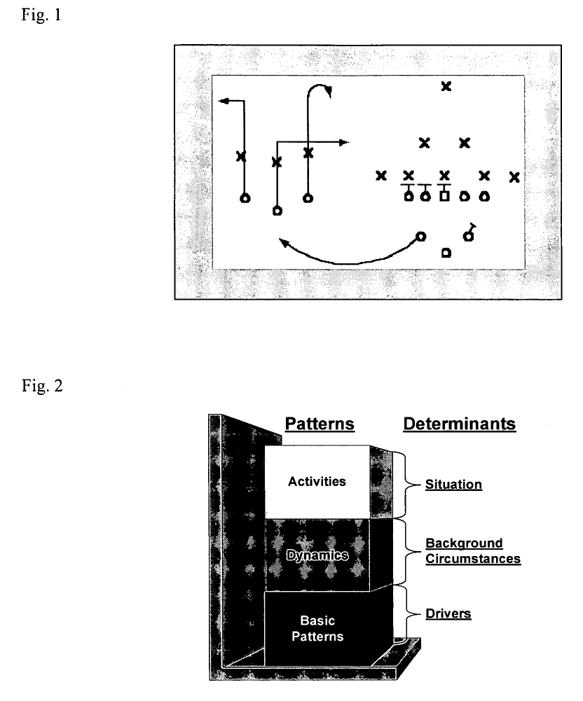

Of course, the other team also has plays and therefore the players must improvise on the fly. The “play” describes the roles for of each of the players. FIG. 1 below describes a “Trips Left 346 R-Swing” play. It maps out what each player must do in relation to the opposing team.

The patterns in football occur at multiple levels. On the surface are the actions of a particular team on a specific play. This is what the sportscasters report when a team is on the forty-five yard line and moves seven yards up the field in the third quarter, including who carried the ball, who tackled whom and what both teams' players did on the field.

To a novice knowing nothing about football, a game would seem quite chaotic, with players running back and forth and tackling each other and with whistles going off in between. If the novice were persistent, however, he or she would begin to recognize a fairly limited set of patterns (“plays”) and recurred with minor variations. The team's playbook captures these patterns.

Underlying these plays, however, are a deeper set of basic patterns that reveal what is going on in the league, such as which teams are on a roll, the changing fortunes of the various coaches and which players have been traded. These basic factors influence the game but are not apparent when watching the game itself.

Similarly, most situations in most fields also involve patterns that occur on multiple levels. The specific activities in a given situation are on the surface, such as the meetings, the cast of characters, the priorities, etc. These activities represent the rough-and-tumble of everyday life. They are very short-term, changing hour-by-hour or day-by-day.

Underneath, however, are the background circumstances that determine the underlying dynamics that drive the more visible activities. For example, in the field of business, when an organization is going through a merger or downsizing, these circumstances may place a specific view or “spin” on any given situation. These dynamics change in anywhere from several months to a year or two. Finally, there are underlying basic patterns that reflect the relatively stable values, organization culture and business models that drive the organization's activities over five to ten years or more and thus create very stable basic patterns

FIG. 2 represents the three levels of these patterns, each operating in a different time frame. Interestingly, people vary in their ability to see these patterns from one individual to the next. Everyone can see the surface activities at any point. Beyond these, the more experienced professionals are also able to quickly size up the dynamics in a situation because of similar experiences in the past. They have seen similar situations before and understand the implications. Most people cannot see these deeper patterns that are below their radar.

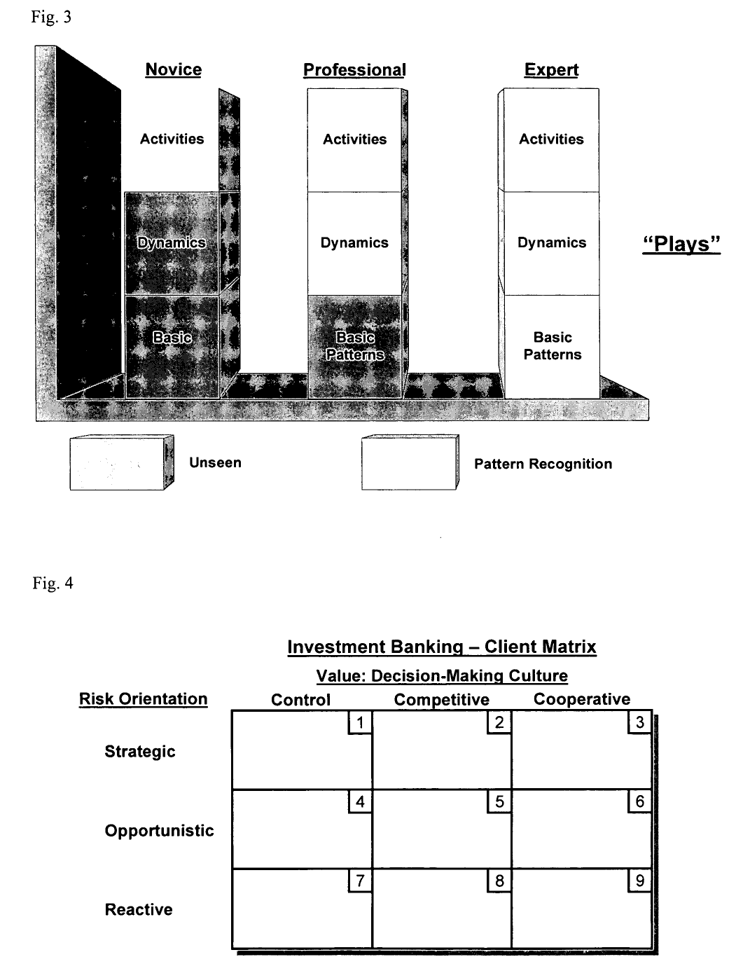

The expert, however, is able to pick up these deeper patterns with relatively few cues. They can almost “sense” these deeper forces and factor them into the overall equation. FIG. 3. illustrates these different levels of understanding.

The expert is able to understand the total situation including the surface activities and the deeper underlying patterns. The question is: How do experts intuitively map these situations? To decipher the patterns, the invention uses a structured dialogue process that can take place either in a workshop environment or through one-on-one interaction.

The process starts with the way experts quickly size up situations that distinguishes them from their less talented colleagues. The key is differentiation. Consider two situations that look similar on the surface to non-experts—for example, two mergers involving oil companies. The expert may treat them very differently, picking up on cues virtually invisible to others. The method of the invention ferrets out how experts differentiate through a process called “The Five Whys.” Experts are asked to choose two situations that look similar on the surface (e.g. two major banking clients) but where the expert intuitively would take a different approach to each. That is, the experts consider situations in which the experts instinctively differentiate between the two seemingly similar situations.

The objective is to find the “root cause” that underlies how they experts implicitly distinguish between the two situations. In other words: What is the underlying difference between the two situations that is so apparent to the expert, but not to others?

“The Five Whys” technique involves the iterative process of asking: Why would you act differently in situation “A” versus situation “B”? When the answer is given in the first round, the question “Why?” is asked again. The process proceeds iteratively until the root cause is determined—the differentiator—typically taking about five rounds of questioning.

The example in FIG. 4 describes the output of the process for clients in an investment banking firm. Expert investment bankers developed the client matrix with the two axes of risk orientation and decision-making culture. This matrix represents an “internal map” of their client strategies that, in effect, already exists in their heads. The invention extracts the implicit model these experts already use in a way that can be shared across the organization.

In order to test and refine the matrix, the experts populate the individual cells with examples from their experience, testing for consistency. Applying real examples brings the matrix to life for the participants and demonstrates its ability to differentiate between various kinds of situations.

Within each of the cells of the matrix, the experts craft simple scenarios that typify the dynamics at play. They are encouraged to tell anecdotes that serve as “parables”—simple stories laden with meaning. The anecdotes give life to the more objective profiles. The profiles contained the key elements including the successful (and unsuccessful) paths taken, the key leverage points, the “landmines,” the “musts”, the deployment logistics and, above all, the “tricks of the trade.”

Drawing on their experience, the experts map out one or more plays in each cell that have a high chance of success. These plays capture the critical paths through the situation, including the major obstacles, leverage points, resource requirements and logistics. The result is a pattern book or “Playbook” that becomes a living memory of the experts' experience in a form that can be transferred to others in the organization. Much as a football team has a playbook that captures its inventory of maneuvers, the pattern book for the organization provides a compact way of capturing and transmitting the experts' knowledge as part of the organizational memory.

Underlying these surface patterns is a deeper layer of patterns based on the stability (and therefore predictability) of human behavior. As an analogous example, Dr. Hans Selye outlined many years ago the classic “fight or flight response” for coping with stress. When attacked, our ancestors had a common pattern of either fiercely attacking the intruder or fleeing as fast as possible. Similarly, in more complex modern situations, a highly stable set of universal patterns also exist that drive behavior in highly consistent, and therefore predictable, ways.

To underscore the simplicity and durability of these deeper patterns, it is interesting to note that Raymond G. Frensham, in Screenwriting, Teach Yourself Books, 1996 relates that Hollywood movies are built on a simple structure of eight plots. These are: 1.) The fatal flaw that leads to the destruction of the previously flawless individual; 2.) The innocents abroad, naive optimism triumphant; the hero (‘good man’) who cannot be kept down; 3.) The dream come true; unrecognized virtue recognized at last; goodness triumphant after being initially despised; rewards achieved through transformed circumstances; 4.) The chase; the spider and the fly; the innocents and the victim; mostly the temptress snaring the love-struck male; 5.) Selling your soul to the devil may bring riches, but eventually there is a price to be paid; the long-term debt; the uncovered secret that catches up with us sooner or later and damns us; the inescapability of fate; 6.) The gift taken away, the loss of something personal. Either about the tragedy of the loss itself or the search which follows the loss; 7.) Boy meets girl, or loses girl, boy finds/does not find girl—it doesn't matter which; and 8.) Triangles (eternal or otherwise); man loves woman and unfortunately, one or both are already spoken for.

These classic plots or patterns in film parallel the levels discussed previously. In movies, what is seen in the theater is the film script portrayed by the actors, with detailed dialogue scene by scene. At a deeper level, the film tells an overall story, for example, about a young Italian coming to America in the 19th century. Finally, at the deepest level is the plot that represents a simple scenario or pattern as in the examples above.

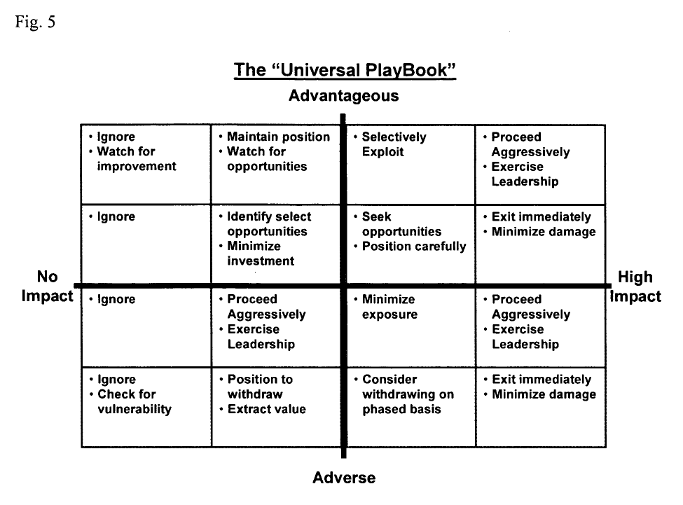

In other situations too, the patterns replicate themselves at a deeper level. The invention maps these patterns and builds a universal pattern book that lays out a set of deep-rooted dynamics in terms of patterns that apply to any given situation. As an analogy, military strategy draws on a set of time-honored maneuvers such as the surprise attack, the pincer movement or the classic diversion. The result is the universal pattern book maps out a common set of patterns, as illustrated in FIG. 5 for a business example.

In FIG. 5, when high performers face a particular business issue, the pattern book maps out a finite set of generic options. They can proceed aggressively, cautiously or work indirectly, depending on the nature of the situation. The greater the impact, the more likely they are to be more proactive. FIG. 5 also shows how they engage or retreat, depending on whether or not the issue is advantageous or adverse. The more advantageous the situation, the more the individual needs to take advantage of the opportunity. The more adverse, the more the individual needs to either do battle or retreat in some form or another.

Any pattern in the universal pattern book can be translated into executable actions for use in practical business situations, in the same way that a film can be translated into one of the eight plots discussed earlier, or vice versa. The patterns in the pattern book apply to wide variety of circumstances. The axes in the matrix form the basic motivators that drive these universal behavior patterns and form archetypical patterns.

The basic logic drives the process from the generic “plays” through to the specific initiatives in a particular situation. The logic is as follows:

“Drive” The motivation to resolve an issue (largely dictated by the “impact” factor, the effect the issue has on the organization)

“Dynamics” Assessment of the forces in motion and the favorable routes through the situation—the root patterns.

“Personification” Describing actors, resources, tactics and timeframes.

“Activation” Logistics of execution with skills and resource requirements.

“Triggers” Critical incidents requiring improvisation.

The purpose of the universal pattern book is to serve as a learning and strategy tool to show the possible plays available in real-life situations. Broadening the repertoire helps people consider a richer set of options and to “think out-of-the-box.”

While the patterns describe the overall dynamics of a situation, they require competencies in order to be executed. In football, for example, a play may require tackling, blocking and passing skills. But these skills are only useful in the context of a “Play” (otherwise people would simply run around tackling each other). In business, whether the issue is large (e.g. how to do a successful acquisition) or small (e.g. how to deal with a non-performing employee), specific competencies will be needed to execute the “plays.”

In the latter case, for example, skills in negotiation might include interviewing, coaching, and how to do a performance review might be necessary to deal with an employee having difficulty in his or her job. Each of the particular competencies may involve a number of “learning points” or specific skills required to be fully competent, for example, in interviewing. However, these learning points need to be set in context for different audiences. Teaching doctors, lawyers or engineers requires different contexts.

In order to place a particular set of learning points in context, specific cases, articles and examples need to be “wrapped around” of the learning points relevant to learner. For example, teaching leadership to lawyers requires legal cases, articles and examples.

Finally, the mode of delivery or pedagogical method also needs to be tailored to the specific situation. For example, formal learning in hospitals typically takes place on Friday mornings, when the doctors make their “rounds.” Thus the formal learning process needs to be integrated with the rounds of process.

The invention may be programmed into software such that the plays and the formal learning points, together with the pedagogical learning processes may be incorporated into a modular format in a database. This database can be accessed by the instructor or, if necessary, by the student.

In constructing such a database processes are required. A process is required to identify key learning points related to specific topic. This process starts with determining what is important to the learner identifying “learning points”: the principals, concepts, theories and frameworks that are retained months and years later.

Such a database of processes would include: A design and customization process to tailor learning materials to different audiences, such as doctors, engineers and lawyers (this involves taking the learning points, which are universal, and integrating cases, articles, videos, etc. (i.e. “contextual material”) meaningful to specific audiences) and an expert pattern recognition process to capture the relatively consistent ways high performing people use to solve business issues.

Because the knowledge required to set up the database is in the heads of the professors or experts, a methodology is required to extract that knowledge. The approach in the embodiment shown here involves structured workshops to help the professor or expert identify the key “learning points” from their own course or teaching materials.

The key focus for a learning point is on what is to be retained by the student, rather than what content must be transferred. Students typically wrestle through huge textbooks and course packs on which they are tested by their professors. Immediately after exams, however, most of this knowledge is lost, except for the important principles and concepts. The learning points represent these major concepts, principles, frameworks, theories and tools retained months or years after the learning experience. These are the fundamentals in the field (for example management) which are relevant to all organizations. Principles, for example in leadership or accounting, apply equally to a hospital, a bank or a government agency. These principles represent common knowledge in the education in a given field.

The workshop steps for developing the learning points are: identify the learning points; create the concept maps; develop a learning strategy and evaluate the transfer of knowledge.

The first step is typically half a day in length and engages the professors/experts in answering the question: “What do you want students to remember six months after the course?”0 The participants are broken up into small groups to develop their own learning points, with the benefit of comparing notes with others. The output from this process is six to eight major learning points that students need to remember and be able to apply.

The second step is one in which the participants are asked how each of the learning points relates to the others. For example, is there a dotted line from learning point 1 to learning point 2 or 3, or is one a subset of the other? The output of this workshop is a visual picture or “concept map” drawn by participants for each course or learning program.

In the third step, participants identify for each learning point the most appropriate strategies for students to internalize the knowledge. For example, a particular learning point might best be absorbed by a site visit to a company, a gaming simulation, a case or a role playing session. The output is a set of learning strategies that are specifically related to the kinds of knowledge (i.e. learning points) that students must master.

In the last step, participants assess alternative ways of evaluating whether students “got it,” and other words, achieved competency. The output is a clear understanding the most appropriate evaluation techniques for each of the learning points.

An example of this process was undertaken in a long-term care facility for the elderly. A persistent problem had been that families of the patients frequently disrupted hospital operations, often seriously. Families were often under great stress due to coping with the illness of the patient, inter-family squabbles, money problems and frustration with the hospital bureaucracy. Some of the incidents were serious enough to end up in court.

Nurses and social workers on the floor were not trained to deal with such situations, many of which were explosive. The result was a perennial problem for which there seemed to be little solution.

However, the answers, if any, were not to be found in textbooks or even in college curricula. They were in the heads of the staff on the floor who had either succeeded or failed in various attempts to deal with such situations but, in any case, learned something. The challenge was to extract the successful coping patterns and make them available more broadly to the staff.

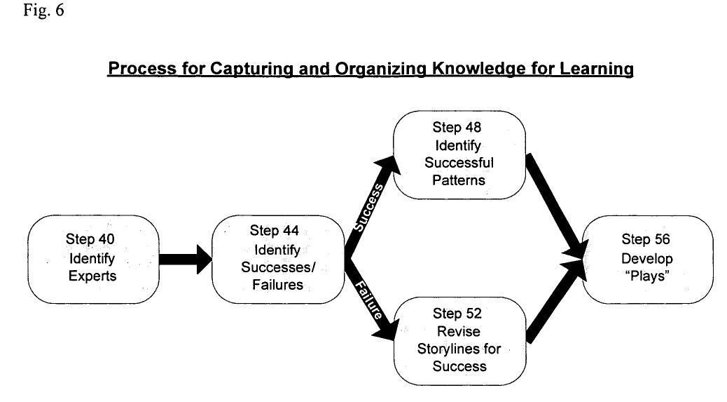

Referring to FIG. 6, the process involved the following steps:

1. Staff who were particularly knowledgeable in this area were identified and brought together for a half-day workshop (Step 40).

2. Each was asked to identify one or more instances where they have encountered difficulties with families (Step 44).

3. Participants then identified how they coped, including what worked and what didn't.

4. Where an intervention was successful, they were asked to tell a story about the incident (Step 48). Where the intervention was not, they were asked to rewrite the description to increase the likelihood of success if they could repeat the experience (Step 52).

Participants were asked to characterize the stories as “plays” or “plot lines.” Some of the “plays” included: Legal plays—Using the threat of legal action to discourage hostile action; Negotiation plays—Working out a quid pro quo agreement with the family to mitigate the situation; Separation plays—Isolating the patient on a different floor or part of the building away from other patients, minimizing the possibility of disruption; Solution plays—Fixing the problem so that it goes away; Stalling plays—Letting time pass to defuse the situation; Escalation plays—Bringing in the doctor or more senior authority into the picture to exert more influence on the family (Step 56).

The successful patterns, once captured, must be then transferred to others. This process involved two steps: 1) practicing drills and 2) learning to improvise. In the same way that football teams practice their plays, managers must practice the successful patterns by doing the following: role-playing sessions with colleagues, acting out the key dynamics of the situation; gaming simulations that allow participants do engage complex material in an experiential way and doing drills that simulate real situations. It should be noted that improvisation is a spontaneous activity that cannot be learned mechanically. Experience and practice in a safe environment, such as a role-playing sessions, can nurture this ability. Coaching or mentoring is often an essential ingredient involving direct feedback from an experienced individual.

Once the material that is to be taught is determined, the examples used in teaching must be directed to the target audience. For example management topics such as leadership, understanding financial statements or teamwork involve universal principles and tools across many organizations, industries and professions. However, doctors need cases, articles and examples from healthcare, not manufacturing, to relate to the material. Similarly, the way learning is delivered similarly varies. For example, doctors typically learn when they do their rounds in the hospital (usually once a week). Lawyers or engineers might have a complete different pattern. Thus while the learning points are universal, the contextual material that makes these points real and the delivery process must be customized to specific audiences.

To customize the material for the learning audience requires three building blocks that are modular and can be combined in different ways. This permits easy customization to specific needs of the audience.

These three building blocks: 1) learning points, 2) contextual material, illustrating the points and 3) learning strategies, are combined to make a “learning module.” A learning point is packaged with relevant contextual material (e.g. cases, articles and examples) and with appropriate learning processes, for example for lawyers, doctors or engineers.

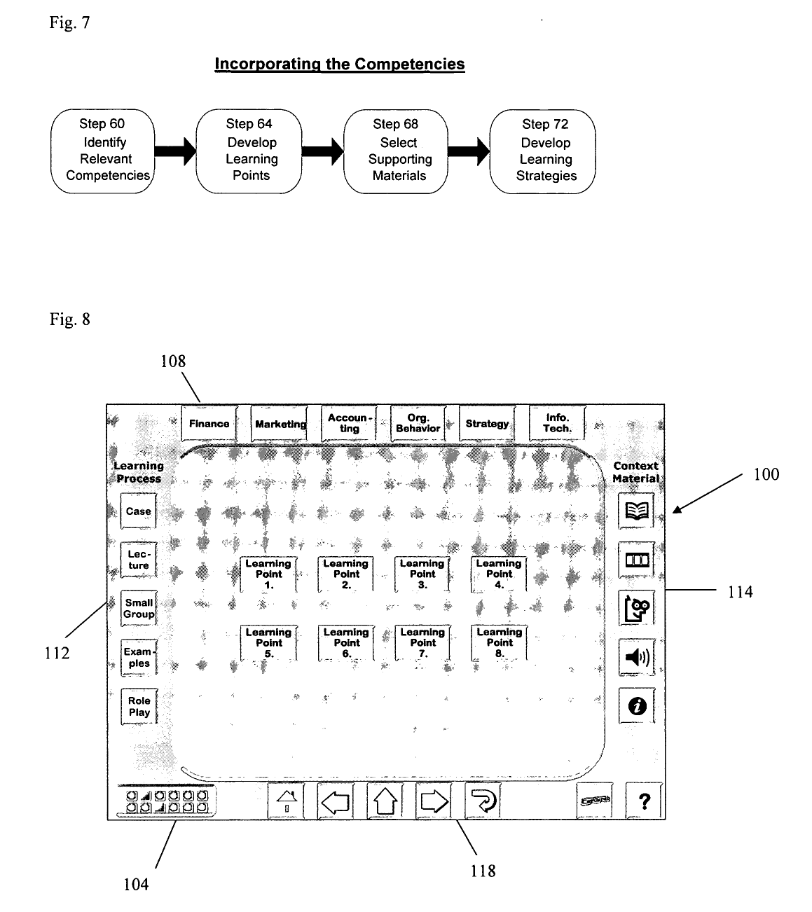

The design team produces a learning module and incorporates an overall director, pedagogical designer, multimedia expert, librarian, interviewer, etc. Referring to FIG. 7, the design team producing the module identifies the major competencies required to execute a particular pattern (Step 60). For example, a specific pattern for a hostile takeover might require such competencies as: negotiations skills, ability to understand financial statements and knowledge of key regulatory issues. The design team then involves one or more appropriate content experts in a meeting or workshop to identify the key “learning points” (major principles, concepts, theories, frameworks, etc.) (Step 64). For each learning point, the design team to identify cases, articles, examples and video clips relevant to a particular target audience (e.g. healthcare professionals, lawyers, etc.) (Step 68). The design team determines the most appropriate the learning strategies for each learning point (e.g. case study, site visit, small group breakout, lecture, debate, role-playing session, etc.), working with the content expert(s) (Step 72).

The design process, as discussed above, involves two major steps: 1) assembling relevant contextual material (i.e. cases, articles and examples) that illustrate and give life to the learning points; and 2) identifying appropriate delivery processes for the appropriate audience. To aid in the design process, the process can be accomplished using a graphics interface with a computer.

For the graphics interface to function, learning points and supporting contextual material are captured within a framework represented by the “Design Dashboard” 100 where every item has its own position and coordinates (FIG. 8). Each topic has approximately half a dozen learning points, each of which may have sub-learning points. For example, the concept of supply and demand in economics represents an important learning point 104 for students. “Elasticity of demand” represents a “sub-learning point.” Each learning point 104 is entered on the “Dashboard” and is given a reference as: learning point 1, to, 3, etc. The learning point 104 is entered in the form of text and diagrams and is stored in a knowledge database. In the design process, each learning point 104 is entered into the system using the Design Dashboard for a specific topic in a course or learning program.

The Dashboard remains the same for all topics 108 in the field, (for example management) providing a consistent design and learning environment. With the Dashboard, the orientation of the designer and the learner are the same. In one embodiment the “topics” 108 are always on the top of the frame, the learning processes 112 on the left, contextual materials on the right 114, navigation on the bottom 118 and learning points 104 in the center.

Each topic 108 or learning program has an associated set of learning points 108 that have been identified by the professors/experts. These may be in the form of text and/or diagrams that expressly fundamental principals, ideas, concepts, etc. For example, in risk management, a learning point 104 might focus on the concept of: “tolerance for risk.” The associated learning point 104 would represent the definition(s), descriptive and other explanatory material, necessary for the learner to understand the point. Thus the learning process is designed “backwards,” starting with what must be retained and then designing the process appropriately and the learning points are entered into the Design Dashboard 100.

Each learning point 104 has attached to it specific sets of contextual material 114 for particular audiences, for example, engineers, doctors or bankers. The framework categorizes every item as either an article, video clip, reference or personal contact with experience (i.e. to act as a mentor, advisor, etc.).

Each learning point 104 also has associated with it a set of learning strategies. For example, the concept “tolerance for risk” in risk management mentioned earlier can be learned in a variety of ways including: reading articles, doing a case study, debating key points in class or doing a site visit to a relevant corporation. A finite number of learning strategies exist for all of management education, but a particular one may be more relevant for a specific learning point.

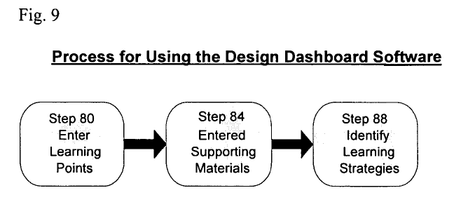

Referring to FIG. 9 each learning point is captured using the Design Dashboard by clicking on one of the learning point buttons. In the fields that then appear, the information (in the form of text and/or illustrations) is entered (Step 80). For each learning point, the related cases, articles, videos and examples are entered by clicking on one of the appropriate buttons on the right of the screen under the heading: “Context Material” (Step 84). The buttons are marked according to the type of material to be captured (e.g. text, videos, etc.) For each learning point, the appropriate learning strategies are entered by clicking on the buttons on the left side of the screen under the heading: “Learning Processes” (Step 88).

The Dashboard also indicates both to the designer and learner how to navigate through the material. Every item must fall into a specific category: a learning point, contextual material or learning strategy. Thus every piece of information has its own coordinates, tied to the Design Dashboard. This is in sharp contrast to the Internet, where information exists in an almost infinite web in different locations and in different formats. The navigation controls are located at the bottom of the Dashboard.

Learners have access to a structured framework where they can access the knowledge in a variety of ways. Probably most people would start off with a specific learning point they want to absorb. Then, they can access the material through the video clips, reading articles, identifying experts to contact, depending on their preferences.

If a professor or expert is involved, he/she may use any one of the learning processes on the left side of the Dashboard, as appropriate. Students may be taken through a case, a lecture, small group breakout, etc.

The embodiments shown are exemplary and the scope of the invention is limited only by the scope of the claims.

What is claimed is:

1. A method for use in providing a framework for capturing and organizing knowledge in learning, the method comprising:
determining patterns that experts use across different situations;
based on said patterns, customizing concepts and tools for people who lack expertise; and
integrating and packaging learning modules for competencies required to execute said patterns.

2. The method of claim 1 wherein the patterns comprise a hierarchy of sub-patterns and wherein each of the sub-patterns has a predefined relationship with other sub-patterns.

3. The method of claim 2 wherein each pattern comprises a plurality of learning points and the relationship between the learning points.

4. A method for use in aiding learning, the method comprising:
identifying standard scenarios;
identifying strategies applied by experienced actors to said standard scenarios; and
providing learning modules for concepts and tools that are customized to a learner's context to help said learner learn said strategies.

5. A method for organizing learning comprising the steps of:
capturing patterns used by experts;
organizing into a framework the patterns used by experts;
identifying competencies required to execute the patterns; and
customizing cases to put the competencies into context.

6. The method of claim 5, wherein the step of capturing the patterns used by experts comprise the steps of:
defining learning points;
determining the interrelationship between learning points;
identifying strategies for teaching each learning point; and
identifying ways to evaluate the results of the teaching strategy.

7. A graphical interface for teaching learning strategies comprising:
topics;
learning points; and
learning strategies,
wherein the topics, learning points and learning strategies are associated to permit a user to move between them.

8. The graphical interface of claim 7 further comprising:
contextual materials; and
navigation icons.
